(19) United States
(12) Patent Application Publication
(10) Pub. No.: US 2025/0300196 A1
(43) Pub. Date: Sep. 25, 2025

(54) SEPARATOR FOR FUEL CELL AND SINGLE CELL FOR FUEL CELL

(71) Applicant: TOYOTA BOSHOKU KABUSHIKI KAISHA, Aichi-ken (JP)

(72) Inventors: Kohei MINOSHIMA, Nagoya-shi (JP); Haruyuki AONO, Aichi-ken (JP)

(73) Assignee: TOYOTA BOSHOKU KABUSHIKI KAISHA, Aichi-ken (JP)

(21) Appl. No.: 19/077,864

(22) Filed: Mar. 12, 2025

(30) Foreign Application Priority Data
Mar. 22, 2024 (JP) 2024-046900

(51) Int. Cl. H01M 8/0265

(52) U.S. Cl. CPC H01M 8/0265

(57) ABSTRACT

A separator is configured to be stacked on a power generating unit and a frame, which is made of a plastic and surrounds a peripheral portion of the power generating unit, thereby forming a single cell of a fuel cell. The separator includes a through-hole configured to allow a reactant gas to flow in a thickness direction of the separator, a gas passage configured to allow the reactant gas to flow in a planar direction of the separator, and a rib that is configured to support the frame and surrounds the through-hole over an entire circumference. At least one groove-shaped connecting passage is formed in a top surface of the rib to connect the through-hole and the gas passage to each other. The depth of the connecting passage is less than the thickness of the rib.

### CROSS-REFERENCE TO RELATED APPLICATIONS

This application is based upon and claims the benefit of priority from Japanese Patent Application No. 2024-046900, filed on Mar. 22, 2024, the entire contents of which are incorporated herein by reference.

### BACKGROUND

### 1. Field

The present disclosure relates to a separator for a fuel cell and a single cell for a fuel cell.

### 2. Description of Related Art

A fuel cell is formed by stacking multiple single cells. Each single cell includes a membrane electrode gas diffusion layer assembly, a frame surrounding the membrane electrode gas diffusion layer assembly, and two plate-shaped separators sandwiching the membrane electrode gas diffusion layer assembly and the frame. Each separator includes through-holes configured to allow reactant gas to flow in a thickness direction of the separator and gas passages configured to allow the reactant gas to flow in a planar direction of the separator.

Japanese Laid-Open Patent Publication No. 2022-166475 discloses a separator and separate pieces, which are distinct from the separator. Each separate piece is attached to one of the through-holes of the separator. Each separate piece has the shape of a plate. The separate piece includes a connection hole, grooves, and cutout portions. The grooves and the cutout portions are continuous with the connection hole. The connection hole extends through the separate piece in the thickness direction and is continuous with a through-hole of the separator. The grooves are formed in a portion of the separate piece that is close to the connection hole. The cutout portions are formed in a peripheral portion of the separate piece. The connection hole, the grooves, and the cutout portions form connecting passages that connect the through-hole and the gas passages to each other. Reactant gas flows between the through-hole and the gas passages through the connecting passages.

In the separator described in the above publication, the connecting passages are formed by the separate pieces attached to the separator. This may complicate the structure of the separator.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a plate-shaped separator for a fuel cell is configured to be stacked on a power generating unit and a frame thereby forming a single cell of the fuel cell. The power generating unit includes a membrane electrode assembly. The frame is made of a plastic and surrounds a peripheral portion of the power generating unit. The separator includes a through-hole configured to allow a reactant gas to flow in a thickness direction of the separator, a gas passage configured to allow the reactant gas to flow in a planar direction of the separator, and a rib protruding on one side in the thickness direction. The rib is configured to support the frame and surrounding the through-hole over an entire circumference. At least one groove-shaped connecting passage is formed in a top surface of the rib to connect the through-hole to the gas passage. A depth of the connecting passage is less than a thickness of the rib.

In another general aspect, a single cell for a fuel cell includes a power generating unit that includes a membrane electrode assembly, a frame that is made of a plastic and surrounds a peripheral portion of the power generating unit, and a plate-shaped separator stacked on the power generating unit and the frame. The separator includes a through-hole configured to allow a reactant gas to flow in a thickness direction of the separator, a gas passage configured to allow the reactant gas to flow in a planar direction of the separator, and a rib protruding on one side in the thickness direction. The rib supports the frame and surrounding the through-hole over an entire circumference. A groove-shaped connecting passage is formed in a top surface of the rib to connect the through-hole and the gas passage to each other. A depth of the connecting passage is less than a thickness of the rib.

Other features and aspects will be apparent from the following detailed description, the drawings, and the claims.

### BRIEF DESCRIPTION OF THE DRAWINGS

FIG. 1 is an exploded perspective view showing the structure of a single cell according to an embodiment.

FIG. 2 is a plan view of a rib of the separator shown in FIG. 1.

FIG. 3 is a cross-sectional view of the single cell, taken along line 3-3 of FIG. 2.

FIG. 4 is a cross-sectional view of the single cell, taken along line 4-4 of FIG. 2.

FIG. 5 is a plan view of a rib of a separator according to a first modification.

FIG. 6 is a cross-sectional view of a rib of a separator according to a second modification.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

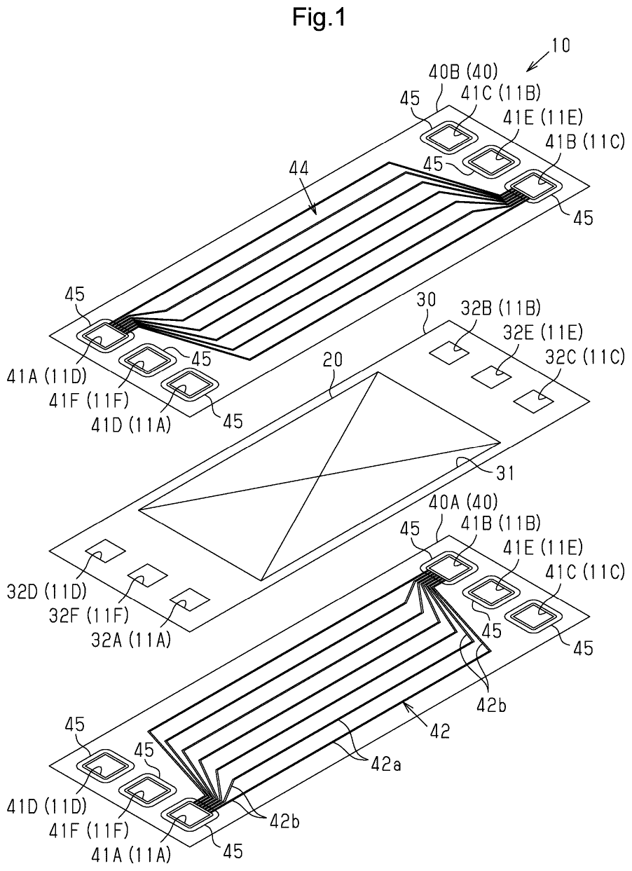

A separator for a fuel cell and a single cell for a fuel cell according to an embodiment will now be described with reference to FIGS. 1 to 4.

As shown in FIG. 1, the fuel cell is formed by stacking single cells 10. Each single cell 10 includes a sheet-shaped power generating unit 20, a frame 30, and two separators 40. The frame 30 surrounds a peripheral portion of the power generating unit 20. The separators 40 sandwich the power generating unit 20 and the frame 30 in the thickness direction. The single cell 10 has, for example, a rectangular shape having long sides and short sides, in plan view.

Although not illustrated, the power generating unit 20 includes a membrane electrode assembly, an anode gas diffusion layer, and a cathode gas diffusion layer. The anode gas diffusion layer and the cathode gas diffusion layer sandwich the membrane electrode assembly in the thickness direction.

The frame 30 includes an accommodation hole 31 that accommodates the power generating unit 20. The material of the frame 30 is, for example, a plastic such as polyethylene terephthalate (PET).

The separator 40 has the shape of a plate. The material of the separator 40 is, for example, a metal material such as titanium or stainless steel or a composite material including conductive particles and a plastic material.

One of the two separators 40 is an anode separator 40A, which is stacked on the anode-side surface of the power generating unit 20. The other one of the two separators 40 is a cathode separator 40B, which is stacked on the cathode-side surface of the power generating unit 20. The anode separator 40A and the cathode separator 40B are, for example, identical in shape. The anode separator 40A and the cathode separator 40B sandwich the power generating unit 20 and the frame 30, while being arranged in orientations inverted with respect to each other.

The single cell 10 includes manifolds 11A, 11B, 11C, 11D, 11E, 11F, which allow fluid to flow in the thickness direction of the separator 40. The manifolds 11A, 11B, 11C, 11D, 11E, 11F extend through the two separators 40 and the frame 30. The fluid is, for example, a coolant or a reactant gas such as hydrogen gas or air.

At one end of the single cell 10 in the long-side direction, the manifolds 11A, 11F, and 11D are arranged in this order from one side in the short-side direction. At the opposite end of the single cell 10 in the long-side direction, the manifolds 11C, 11E, and 11B are arranged in this order from one side in the short-side direction.

The frame 30 includes through-holes 32A, 32B, 32C, 32D, 32E, 32F that form the manifolds 11A, 11B, 11C, 11D, 11E, 11F, respectively.

The anode separator 40A includes through-holes 41A, 41B, 41C, 41D, 41E, 41F that form the manifolds 11A, 11B, 11C, 11D, 11E, 11F, respectively. The cathode separator 40B includes through-holes 41D, 41C, 41B, 41A, 41E, 41F that form the manifolds 11A, 11B, 11C, 11D, 11E, 11F, respectively.

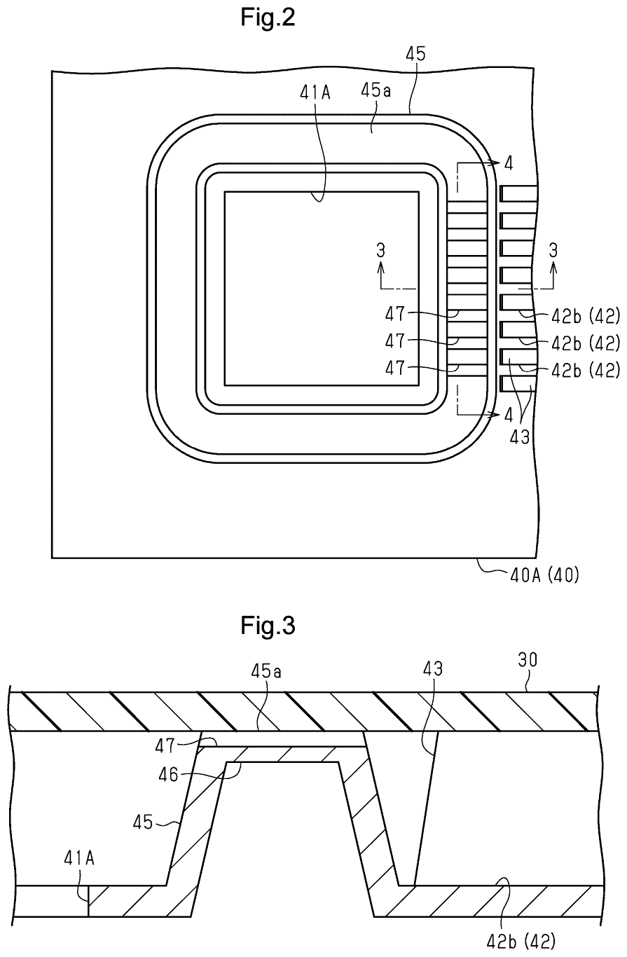

The separator 40 includes groove-shaped gas passages 42 configured to allow the reactant gas to flow in a planar direction of the separator 40. The gas passages 42 are formed in a surface of the separator 40 that faces the power generating unit 20. The gas passages 42 are arranged between protrusions 43 (refer to FIGS. 2 and 3), which protrude in the thickness direction of the separator 40 and extend in parallel in a planar direction.

Each gas passage 42 includes a first section 42a, which extends in the long-side direction in a center portion of the separator 40, and two second sections 42b, which extend from the opposite ends of the first section 42a toward the through-holes 41A, 41B. The gas passages 42 of the anode separator 40A allow hydrogen gas supplied from the through-hole 41A to flow toward the through-hole 41B. The gas passages 42 (not shown) of the cathode separator 40B allow air supplied from the through-hole 41B to flow toward the through-hole 41A.

The separator 40 includes grooves-shaped cooling passages 44 configured to allow coolant to flow in a planar direction of the separator 40. The cooling passages 44 are formed in a surface of the separator 40 that is on a side opposite to the surface in which the gas passages 42 are formed. The cooling passages 44 allow the coolant supplied from the through-hole 41E to flow toward the through-hole 41F. Between two adjacent single cells 10 stuck in the stacking direction, the coolant flows between the cooling passages 44 of the anode separator 40A of one of the single cells 10 and the cooling passages 44 of the cathode separator 40B of the other single cell 10.

The separator 40 includes ribs 45 that entirely surround each of the through-holes 41A, 41B, 41C, 41D, 41E, and 41F. Each rib 45 protrudes from one side in the thickness direction of the separator 40 and supports the frame 30.

As shown in FIGS. 2 and 3, each rib 45 includes a flat top surface 45a that supports the frame 30. For example, the ribs 45 are formed integrally with the separator 40 by pressing the base material of the separator 40. Accordingly, as shown in FIG. 3, a recess 46 is formed on the back of each rib 45. The bottom surface of the recess 46 located on the side opposite to the top surface 45a of the rib 45 is flat. A gasket for providing a seal between two adjacent cells 10 in the stacking direction may be provided in the recess 46.

Groove-shaped connecting passages 47 are formed in the top surfaces 45a of the ribs 45 that surround the through-holes 41A, 41B to connect the through-holes 41A, 41B to the gas passages 42. The connecting passages 47 are arranged on the top surface 45a of the rib 45 at intervals in the circumferential direction of the rib 45. The through-holes 41A, 41B and the gas passages 42 are connected to each other via the connecting passages 47.

As shown in FIG. 2, each connecting passage 47 extends, for example, linearly. The connecting passages 47 are directed to the ends of the respective second sections 42b.

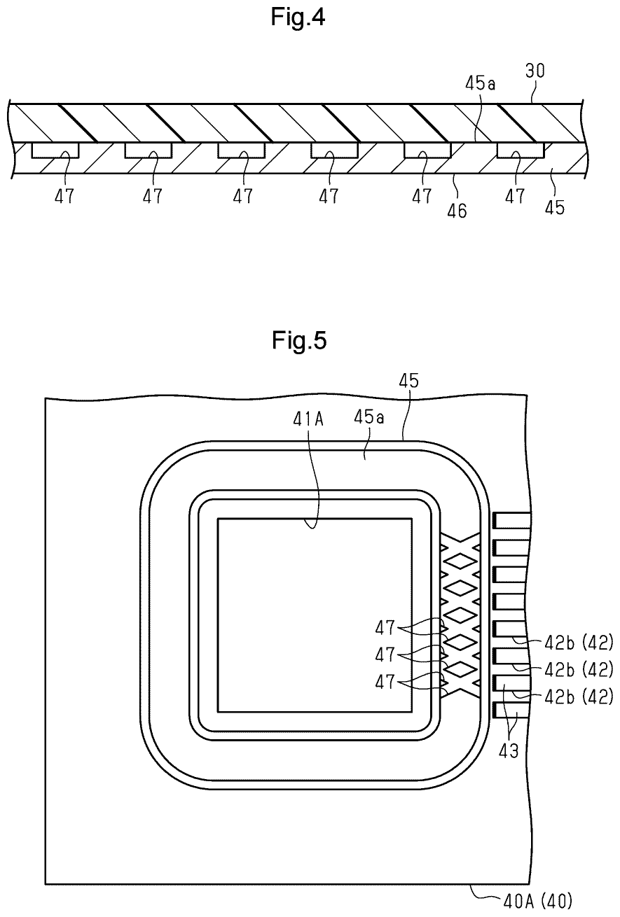

As shown in FIG. 4, the connecting passages 47 open in the protruding direction of the corresponding rib 45 in the top surface 45a. The flat portion of the frame 30 is in contact with the top surface 45a. The openings of the connecting passages 47 are thus covered by the flat portion of the frame 30.

The cross-sectional shape orthogonal to the length direction of each connecting passage 47 is rectangular. The depth of the connecting passages 47 is less than the thickness of the rib 45. The connecting passages 47 are formed, for example, by irradiating the top surface 45a of the rib 45 with a laser beam. The connecting passages 47 are formed in the rib 45 within the range of the thickness of the rib 45.

### Operation and Advantages of the Present Embodiment

The reactant gas flows between each of the through-holes 41A, 41B and the gas passages 42 via the connecting passages 47. The connecting passages 47 are formed in the top surfaces 45a of the ribs 45 surrounding the through-holes 41A, 41B and covered by the frame 30. Therefore, it is not necessary to prepare components separate from the separator 40 in order to provide the connecting passages 47 in the separator 40 This prevents the structure of the separator 40 from being complicated.

Furthermore, since the depth of the connecting passages 47 is less than the thickness of the rib 45, the connecting passages 47 can be formed by a material removal process applied to the rib 45, such as laser machining. This adds to the flexibility in the shape of the connecting passages 47.

### Modifications

The above-described embodiment may be modified as follows. The above-described embodiment and the following modifications can be combined as long as the combined modifications remain technically consistent with each other.

The connecting passages 47 may be formed by cutting or electrical discharge machining applied to the rib 45.

Alternatively, the connecting passages 47 may be formed by transferring the recesses and protrusions of a die onto the top surface 45a during pressing of the rib 45.

As shown in FIG. 5, the connecting passages 47 may be formed in the top surface 45a of the rib 45 to be continuous with each other. Each connecting passage 47 in this modification extends linearly and is inclined with respect to a direction orthogonal to the circumferential direction of the corresponding rib 45. Any two of the connecting passages 47 that are adjacent to each other extend in different directions and are connected to each other at a center in the longitudinal direction of each connecting passage 47. Since the temperature of the fuel cell at the time of power generation is relatively high, the plastic frame 30 may be softened. In this case, when the softened frame 30 partially intrudes into the connecting passages 47, the cross-sectional area of the connecting passages 47 may decrease. This may reduce the flow rate of the reactant gas flowing through the connecting passages 47, and thus reduce the flow rate of the reactant gas flowing through the gas passages 42. As a result, the power generation efficiency of the fuel cell may decrease. In this regard, the present modification connects the connecting passages 47 to each other. Thus, even if the frame 30 partially intrudes into one of the connecting passages 47, the flow of the reactant gas is unlikely to decrease since the reactant gas flows through the other connecting passages 47, which are connected to the obstructed connecting passage 47. This limits a decrease in the power generation efficiency of the fuel cell.

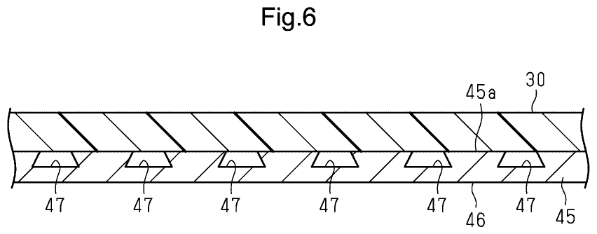

The cross-sectional shape of each connecting passage 47 is not limited to a rectangle and may be any of a variety of shapes. For example, as shown in FIG. 6, the width of each connecting passage 47 may gradually increase toward the bottom wall of the connecting passage 47. The cross-sectional shape of the connecting passage 47 in this modification is a trapezoid. Additionally, the cross-sectional shape of the connecting passage 47 may be such that one side surface in the width direction is perpendicular to the bottom surface, while the other side surface is inclined relative to the bottom surface. This shape may be achieved by performing laser irradiation on the top surface 45a of the rib 45 from an inclined direction relative to the normal direction of the top surface 45a. With this configuration, the portion of the connecting passage 47 closer to the bottom wall occupies a larger proportion of the cross-sectional area of the connecting passage 47 compared to the portion farther from the bottom wall. Accordingly, even the softened frame 30 partially intrudes into the connecting passages 47, the configuration ensures that a sufficient flow region for the reactant gas remains within the connecting passages 47.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. A plate-shaped separator for a fuel cell, the separator being configured to be stacked on a power generating unit and a frame thereby forming a single cell of the fuel cell, the power generating unit including a membrane electrode assembly, and the frame being made of a plastic and surrounding a peripheral portion of the power generating unit, the separator comprising:
a through-hole configured to allow a reactant gas to flow in a thickness direction of the separator;
a gas passage configured to allow the reactant gas to flow in a planar direction of the separator; and
a rib protruding on one side in the thickness direction, the rib being configured to support the frame and surrounding the through-hole over an entire circumference, wherein
at least one groove-shaped connecting passage is formed in a top surface of the rib to connect the through-hole to the gas passage, and
a depth of the connecting passage is less than a thickness of the rib.

2. The separator for the fuel cell according to claim 1, wherein the at least one connecting passage is one of multiple connecting passages that are formed in the top surface of the rib and are continuous with each other.

3. The separator for the fuel cell according to claim 1, wherein a width of the connecting passage gradually increases toward a bottom wall of the connecting passage.

4. A single cell for a fuel cell, comprising:
a power generating unit that includes a membrane electrode assembly;
a frame that is made of a plastic and surrounds a peripheral portion of the power generating unit; and
a plate-shaped separator stacked on the power generating unit and the frame, wherein
the separator includes:
a through-hole configured to allow a reactant gas to flow in a thickness direction of the separator;
a gas passage configured to allow the reactant gas to flow in a planar direction of the separator; and
a rib protruding on one side in the thickness direction, the rib supporting the frame and surrounding the through-hole over an entire circumference,
a groove-shaped connecting passage is formed in a top surface of the rib to connect the through-hole and the gas passage to each other, and
a depth of the connecting passage is less than a thickness of the rib.
